(19) United States
(12) Patent Application Publication
(10) Pub. No.: US 2016/0124782 A1
(43) Pub. Date: May 5, 2016

(54) SYSTEMS AND METHODS FOR COMMUNICATION BETWEEN INDEPENDENT COMPONENT BLOCKS IN MOBILE APPLICATION MODULES

(71) Applicants: Scott Gruby, San Diego, CA (US); Stephen Charles Kalkwarf, Tewksbury, MA (US)

(72) Inventors: Scott Gruby, San Diego, CA (US); Stephen Charles Kalkwarf, Tewksbury, MA (US)

(21) Appl. No.: 14/530,378

(22) Filed: Oct. 31, 2014

(51) Int. Cl. G06F 9/54

(52) U.S. Cl. CPC G06F 9/546

(57) ABSTRACT

Embodiments of methods and devices for creating and using independent component blocks and application modules are described. One example embodiment involves a method where a first application module and a second application module each register with a uniform resource locator (URL) handler module of a mobile device to associate a protocol name with the respective application module. The modules may then use the protocol names to send messages to other application modules using the protocol names, with the messages being relayed or communicated via a communication routing module. Additional embodiments may involve various applications receiving these messages, which may be structured as URLs. The applications may then parse the messages using URL parsers in the application to identify commands and data within messages.

### TECHNICAL FIELD

Example embodiments relate generally to communication systems, and in particular, to systems and methods for communications between component blocks in mobile application modules.

### BACKGROUND

Application environments, and particularly mobile application environments, may limit communications for a variety of reasons. Security and performance may be reasons why a particular application environment limits the ability of applications to communicate with each other and with network systems. This creates environments in which independent applications or component blocks of applications may need to be bundled in order to allow communications between them. Such bundling creates inefficiencies, and may require multiple applications that perform identical functions in the same environment.

### BRIEF DESCRIPTION OF THE DRAWINGS

Some embodiments are illustrated by way of example and not limitation in the figures of the accompanying drawings in which:

FIG. 1A illustrates a block diagram of a device, in accordance with an example embodiment, for communications between independent application modules.

FIG. 1B illustrates a block diagram of a device, in accordance with an example embodiment, for communications between independent component blocks.

FIG. 2 illustrates a communication, in accordance with an example embodiment, between a first independent component block and a second independent component block in a device.

FIG. 3 illustrates a message, in accordance with an example embodiment, that may be used as a communication between independent component blocks in an example embodiment.

FIG. 4A illustrates aspects of a method, in accordance with an example embodiment, for communicating between independent component blocks.

FIG. 4B illustrates additional aspects of a method, in accordance with an example embodiment, for communicating between independent component blocks.

FIG. 5 is a network diagram depicting a network system, according to one embodiment, having a client server architecture configured for exchanging data over a network;

FIG. 6 is a block diagram illustrating an example embodiment of multiple network and marketplace application modules which may include or function with independent component blocks

FIG. 7 is a block diagram representation of machine in the example form of a computer system within which a set of instructions for causing the machine to perform any one or more of the methodologies discussed herein may be executed.

### DETAILED DESCRIPTION

Example methods and systems for communications between independent component blocks are described. In the following description, for purposes of explanation, numerous specific details are set forth in order to provide a thorough understanding of example embodiments. It will be evident, however, to one skilled in the art, that the present invention may be practiced without these specific details.

Certain example embodiments relate particularly to using unique protocol names to route messages between applications or between component blocks of application. For example, in one potential embodiment, a mobile device may be used in a merchant environment. The mobile device may have multiple applications running on the mobile device in a mobile application environment. The mobile application environment may provide a simple and user friendly way to download the applications to the mobile device, but may limit the ability of the applications to communicate with each other. Each application in the example embodiment, however, is able to send and receive uniform resource locator (URL) messages. Further, each application may register with a URL handler to associate a protocol name with each application. Thus, in addition to standard protocols such as hypertext transport protocol (HTTP), file transfer protocol (FTP), and HTTP secure (HTTPS), the URL handler may register additional protocols and associate them with particular applications. A first application may know a protocol name associated with a second application, and may issue a URL request. When the URL handler receives the URL request, it will route the URL request to the second application. The URL request may include commands and information for the second application, as well as the protocol name for the first application that will allow the second application to send a return message to the first application.

This use of independent application modules or independent component blocks can improve efficiency in an electronic device by preventing redundant modules that are unable to communicate with each other. This can reduce device memory resource usage by enabling a single independent embodiment of an application or component block, rather than multiple copies that are bundled together with other components in dependent groups as multiple applications that are unable to communicate with each other. This may further reduce network usage by enabling independent modules to be downloaded to a device rather than multiple copies of a module being downloaded in different applications with other component modules.

An “independent application” as described herein refers to a set of one or more programs or instruction sets that carry out a predetermined group of operations. Applications are referred to as independent when a first application does not require a second application to carry out the predetermined group of operations. Such independent applications, however, may include operations for communicating between independent applications, and for using information from other applications to enhance or control the operations of the independent application, even thought the independent application does not require the communications from the other application to operate.

An “independent component block” may refer an independent application, but an independent component block may also refer to a portion of an application if the application has multiple independent component blocks. In certain embodiments, a first independent application may be integrated with a second independent application to create a third independent application that has a first component block and a second component block. Such component blocks may retain their independent ability to communicate with other applications and/or other component blocks, and the component blocks may each register an associated protocol name with a URL handler even if the component blocks are part of the same independent application.

An “independent element” as used herein refers generically to either an application module or a component block that is implemented in accordance with the embodiments described herein.

This structure allows both independent applications and independent component blocks to be created and used modularly without a need to customize communications between the blocks in different implementations. This is possible as long as each application or block is able to register with a separate protocol name, and as long as each application or block is able to send and receive URL messages.

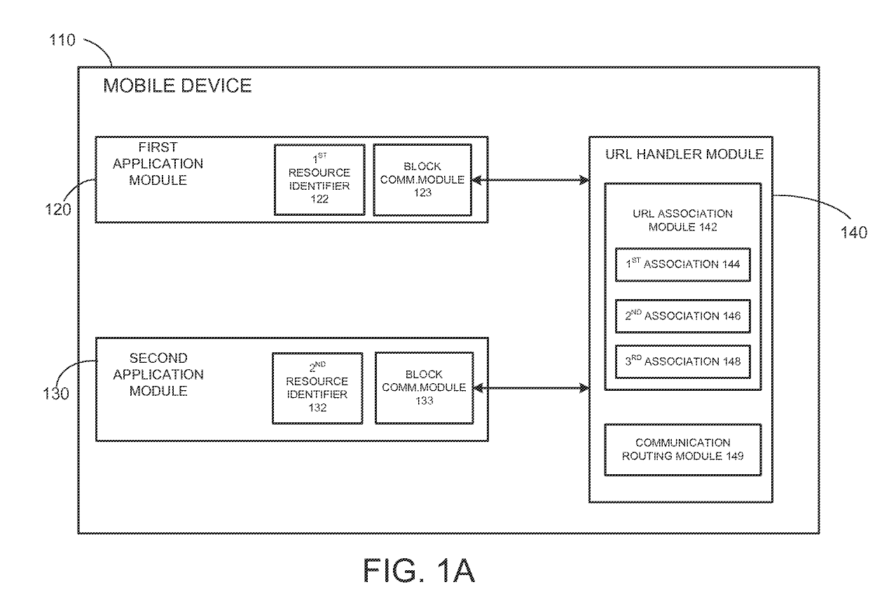

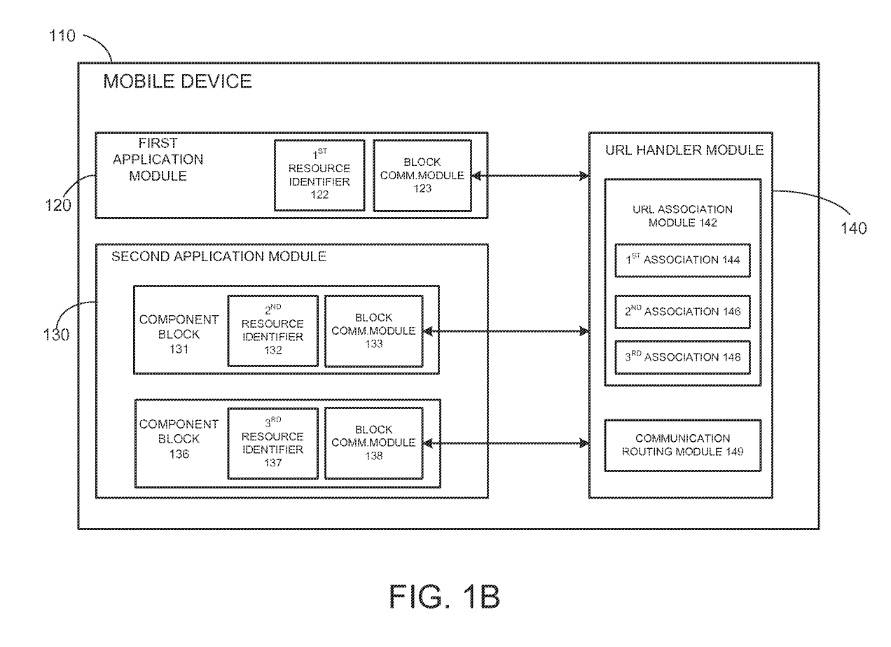

FIG. 1A illustrates a block diagram of a device, in accordance with an example embodiment, for communications between independent application modules. In particular FIG. 1A illustrates mobile device 110. As shown in FIG. 1A, mobile device 110 includes first application module 120, second application module 130, and URL handler module 140. First application module 120 includes 1^{st} resource identifier 122 and block communication module 123. Second application module 130 a 2^{nd} resource identifier 132 and block communication module 133. URL handler module 140 includes URL Association module 142 and communication routing module 149. The URL Association module 142 includes a 1^{st} Association 144, a 2^{nd} Association 146, and a 3^{rd} Association 148.

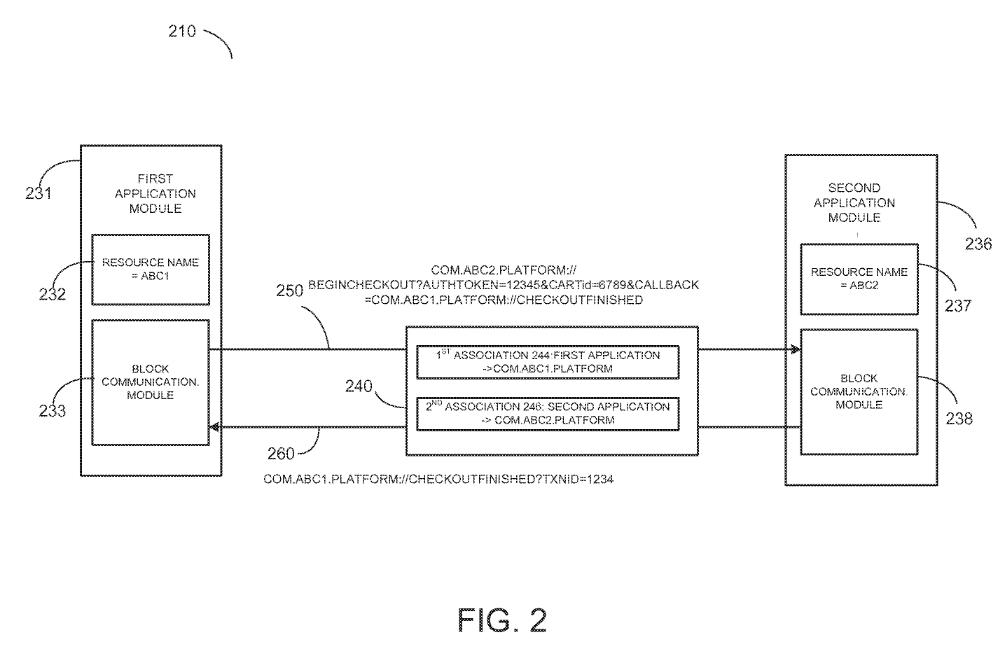

FIG. 1B then illustrates a block diagram of a device, in accordance with an example embodiment, for communications between independent component blocks. As illustrated by FIG. 2, the difference with FIG. 1 is that second application module 130 is shown as including component blocks 131 and 136. Component block 131 includes the 2^{nd} resource identifier 132 and the block communication module 133 which is shown in FIG. 1. Component block 136 includes a 3_{rd} resource identifier 137 and block communication module 138. For purposes of communication between independent elements, communication block s and application modules will function in a similar fashion, with the difference being that multiple component blocks may be integrated into a single application. Thus, in certain embodiments, an application module having a single component block does not communicate in a functionally different manner than an application described without a component block.

As described above and as illustrated by mobile device 110, application modules and component blocks may each function as independent elements in different structures for independent elements communicating according to the embodiments described herein. First application module 120 may thus operate as an independent element which uses 1^{st} resource identifier 122 and block communication module 123 to register a protocol name with the URL handler module 140. A record of this association may be stored in URL Association module 142. This record may be part of a table, a linked list, or any other record that may be used by the URL handler module 140 to route subsequent messages using communication routing module 149. While three associations with protocol names are shown in URL association module 142, any number of associations such as 1^{st} Association 144, 2^{nd} Association 146, and 3^{rd} Association 148 may be present in various embodiments of a URL Association module.

Similarly, second application module 130 has component blocks 131 and 136 that each function as an independent communication element similar to first application module 120. Similar to first application module 120, component block 131 may also register a protocol name with the URL handler module 140. Component block 136 may also register a protocol name with it the URL handler module 140. The protocol name for component block 131 will be different than the protocol name for component block 136. Thus, even though component block 131 and component block 136 are both part of second application module 130, each is an independent block that may be separately addressed for communication purposes.

The resource identifier value that is associated with each independent element such as the 1^{st} resource identifier 122 of first application module 120, 2^{nd} resource identifier 132 of component block 131, and the 3^{rd} resource identifier 137 of component block 136, may be used directly as the protocol name which is registered with the URL handler module 140. In other embodiments, the protocol name may be derived from such resource identifiers. In still further embodiments, other information may be used to create protocol names which are associated with each independent element. The protocol names are unique among the independent elements of a particular device. The protocol names need not be unique among multiple devices because an additional identifier associated with each device may be used to distinguish the protocol name of an application module or component block operating on a particular device. As unique identifiers, the 1^{st} resource identifier 122 is different than the 2^{nd} resource identifier 132 and the 3^{rd} resource identifier 137. Additionally, the 2^{nd} resource identifier 132 is also different than the 3^{rd} resource identifier 137. This enables unique routing of messages between different component elements.

The independent structure of first application module 120, component block 131, and component block 136 allows the creation of modular elements that may be provided from a server to a user device such as mobile device 110 either as integrated parts of a single application module or as standalone applications. The interoperability between the independent elements will not change regardless of whether each independent element is downloaded to a user device as an independent application module or as an independent component block of a larger application module that integrates multiple component blocks. This creates efficiencies both in development of applications and products for user devices as well as in the ability for users to add or remove service provider options and components from a user device.

A component element as used herein then refers to either an independent application as described above or an independent component block as described above.

The example embodiment of FIG. 1 shows mobile device 110 with the independent elements of first application module 120, component block 131, and component block 136 each communicating only with each other through URL handler module 140 and communication routing module 149. In certain application environments, application modules are intentionally prevented from accessing other communication channels. This prevents an application from maliciously infecting other parts of a device while still enabling network communications. In particular, webpage communications may be performed via a connection between communication routing module 149 and a network module that provides access to an external network such as the Internet. Such a communication channel, however, does not provide direct access to other applications operating on user device such as mobile device 110. By having each independent element such as first application module 120, component block 131, and component block 136, each register a unique protocol name with the URL handler module 140, the communication routing module 149 is used to enable communications between these independent elements. This provides a particular benefit in the application environments described above were such communications are not readily available.

While the example embodiment of FIG. 1 illustrates only connections via communication routing module 149 and URL handler module 140, alternate embodiments may not have limitations on the ability of applications to communicate. In such embodiments, while applications and independent component blocks may be allowed to communicate, the example embodiments described herein still provide the benefit of modularly created independent blocks that may be implemented across multiple devices and platforms using a same standard independent element structure.

FIG. 2 illustrates a communication, in accordance with an example embodiment, between a first application module 120 and a second application module 130 in a mobile device 210. FIG. 2 includes a first application module 231, a second application module 236, and a URL handler module 240. Similar to the component blocks shown in FIG. 1, first application module 231 and second application module 236 each include a resource name and a block communication module. Also similarly, URL handler module 240 includes a first association 244 and a second association 246. First application module 231 includes block communication module 233 and resource name 232. Resource name 232 has a value of ABC1. Second application module 236 includes block communication module 238 and resource name 237. Resource name 237 has a value of ABC2. First association 244 is an association between the first application module 231 and the protocol name com.abc1.platform, which is derived from resource name 232. Second association 246 is an association between the second application module 236 and the protocol name com.abc2.platform, which is derived from resource name 237. As described above, each component block may register a protocol name with a URL handler module such as URL handler module 140 to create the associations.

FIG. 2 also shows a first message 250 and the second message 260. As shown by FIG. 2, the first message 250 and second message 260 are each URL messages. Additional details related to these messages will be described below.

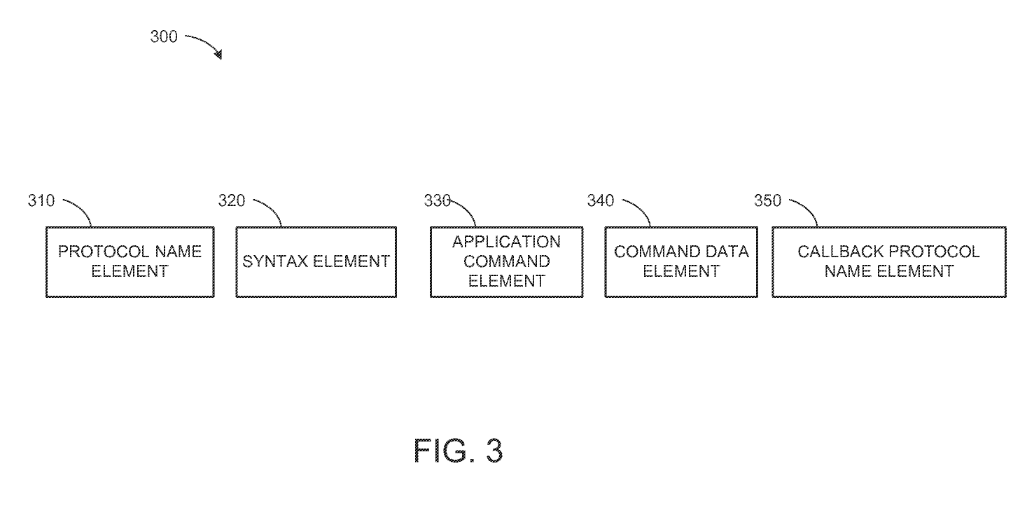

FIG. 3 illustrates a message, in accordance with an example embodiment, that may be used as a communication between independent component blocks in an example embodiment. FIG. 3 includes message 300 which comprises a plurality of message elements. Message 300 includes protocol name element 310, syntax element 320, application command element 330, command data element 340, and callback protocol name element 350.

Protocol name element 310 is the protocol name that was previously associated with the independent element that is the target recipient for message 300. As described above, this may simply be a resource name associated with that target application, or this may be another name derived from the resource name of target application. For example, in FIG. 2, first message 250 includes a protocol name element 310 with a value of COM.ABC2.PLATFORM. This is derived from resource name 237, which is the resource name for second application module 236, which is the target recipient element for the first message 250.

Syntax element 320 may be any syntax separating protocol name element 310 from the application command element 330 and/or the command data element 340 or any other such information. In a standard URL, syntax element 320 comprises a colon and two slashes as “://”

Application command element 330 may be any input command from a first application to a second application. This may include requests for data, instructions to store data, instructions to perform a processing task, or any other such command. Command data element 340 may include data associated with command element 330 such as an identification number associated with the sending element or a modifier to a command from application command element 330.

Callback protocol name element 350 is an optional element that provides an application receiving a message with the protocol name associated with the sending element. This may both serve as an authentication and as routing information for any response that is needed to message 300. For example, in FIG. 2, first message 250 includes a callback protocol name element 350 with the value COM.ABC1.PLATFORM. This value of the callback protocol name element 350 is the protocol name for first application module 231, which is derived from the resource name 232.

As described above, the first message 250, as shown in FIG. 2, includes a structure similar to that of message 300. Not every message, however, must include each of the elements of message 300. For example, message 260 of FIG. 2 does not include a callback protocol name element 350.

Because the messages such as first message 250, second message 260, and message 300 are structured as URLs, a block communication module such as block communication module 123, block communication module 133, block communication module 138, block communication module 233, and block communication module 238 may be optimized for processing URL structures such as the structure described in FIG. 3. As part of this optimized structure, each block communication module may include a specialized URL parser. Such a URL parser may receive a message, parse the protocol name, parse the application command element 330, and parse the command data element 340 automatically if such elements exist in a message 300. This parsing may be done using techniques which are optimized for a URL structure. This may include block-based parsing which leverages information about a limited number of commands that are available within all possible independent elements. This means that the independent applications and independent component modules, which, while created modularly, may have a limited number of commands with each of these commands known to each application or component module. Thus, when an element receives a message, it may use an optimized parsing method because it has information about how all possible independent elements have been created, and knows the possible commands for each element. In other embodiments, parsing may be performed without such information. In still further embodiments, while all possible commands may not be known, standard syntax for URLs may be used to parse out query strings, fragment parameters, name value pairs, callback protocol name elements 350, or any other such information as may be contained in a URL.

In certain implementations, parsing a URL comprises accessing a first parameter dictionary associated with the first application module 231, and parsing the first message 250 using the first parameter dictionary. Such a parameter dictionary may be stored in a memory of the device that contains the application module, and may be shared with other applications or component blocks, or may be used only by a single application, with multiple applications each having their own parameter dictionary. Such a parameter dictionary may include predetermined protocol names and commands, protocol names collected from a URL handler module's stored list of associations, or from other such sources of dictionary entries.

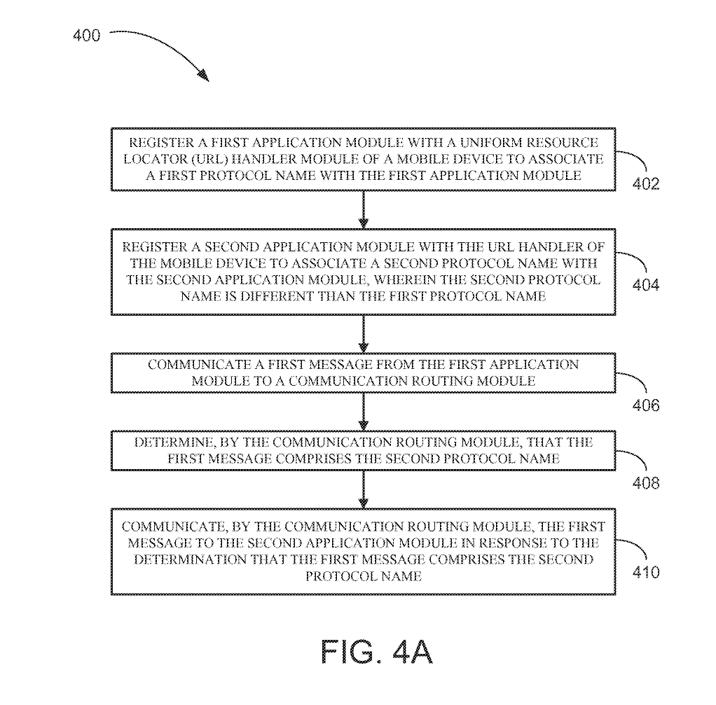

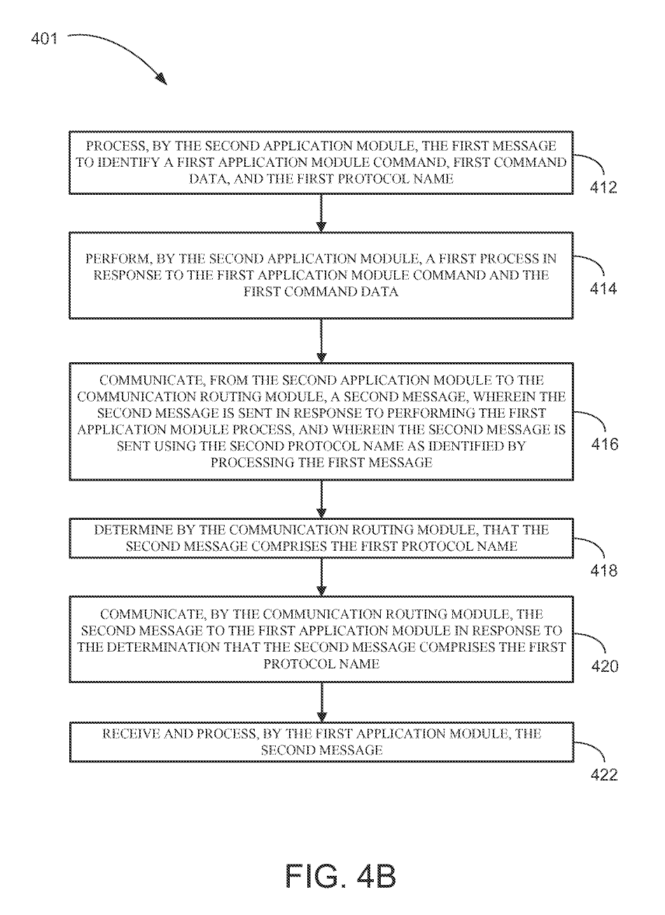

FIG. 4A illustrates aspects of a method 400, in accordance with an example embodiment, for communicating between independent component blocks. While method 400 may be used with a variety of different devices, aspects of method 400 are described below with respect to the example implementations of FIGS. 1 through three. While various example embodiments will be apparent from the descriptions herein, the method of FIG. 4A is described with respect to the mobile device 210 of FIG. 2.

The method 400 begins with operation 402 which includes registering a first application module 231 with a uniform resource locator (URL) handler module 240 of a mobile device 210 to associate a first protocol name with the first application module 231 as part of a first association 244.

The method 400 continues in operation 404 with registering a second application module 236 with the URL handler module 240 of the mobile device 210 to associate a second protocol name with the second application module 236, wherein the second protocol name is different than the first protocol name so that the second association 246 is different than the first association 244. In alternate embodiments, as described above with respect to FIG. 2B, in certain embodiments the associations may be between a component block rather than an application, so that a single application may have multiple protocols associated with the application, but only a single protocol associated with each component block

Operation 406 then involves communicating a first message 250 from the first application module 231 to a communication routing module 149 of URL handler module 240. While in various embodiments, the elements of a communication routing module 149 and a URL association module 142 may be structurally separate, for the purposes of this description, a URL handler module 240 refers to both of these modules, even if they are structurally separate.

Operation 408 involves determining, by the communication routing module, that the first message 250 comprises the second protocol name. This may be done using a URL parser within URL handler module 240 that is similar to the URL parser described above. For example, there parser may access all protocol names with associations in a URL association module. The URL parser within the URL handler module 240 may then parse messages for a match with a protocol name. The association stored in memory for the URL association module 142 may then be used to route a message when the parser finds a match with a protocol name. In other embodiments, standard message parsing may be used, or any other such processing analysis may be used to create this determination. This may be part of an operation 410 then, that involves communicating, by the communication routing module 149 of URL handler module 240, the first message 250 to the second application module 236 in response to the determination that the first message 250 comprises the second protocol name.

FIG. 4B illustrates additional aspects of a method 401, in accordance with an example embodiment, for communicating between independent component blocks. In certain implementations, method 401 may be performed in conjunction with or following method 400. Similarly to the description of method 400 above, method 401 is described in the context of device 210. Alternate implementations of such a method may be performed with other devices.

The embodiment of method 401 begins with operation 412 by processing, by the second application module 236, the first message 250 to identify a first application module command, first command data, and the first protocol name. The example implementation of FIG. 2 shows a first message 250 of “com.abc2.platform://begincheckout?authtoken=12345&cartid=6789&callback=com.abc1.platform://checkoutfinished.” For such a message, the first application command is “begincheckout.” The first command data includes an authorization token with the value “12345” and a cart identifier value of “6789.” The first protocol name is “com.abc2.platform.” This processing to identify the above information may be performed with a URL parser as described above, or may be performed with any other such parser or processing device calculation to extract the above information from the first message. The processing may use template matching, for example, by using a template which is associated with a structure such as the structure shown for message 300, with each element of message 300 associated with a portion of the template. Additional embodiments may include multiple commands within a single message, additional data that is associated with one or more commands, or any other such information. Still further embodiments may additionally process the first message 250 to identify the callback protocol name 350, which in the first message 250, is “com.abc1.platform.”

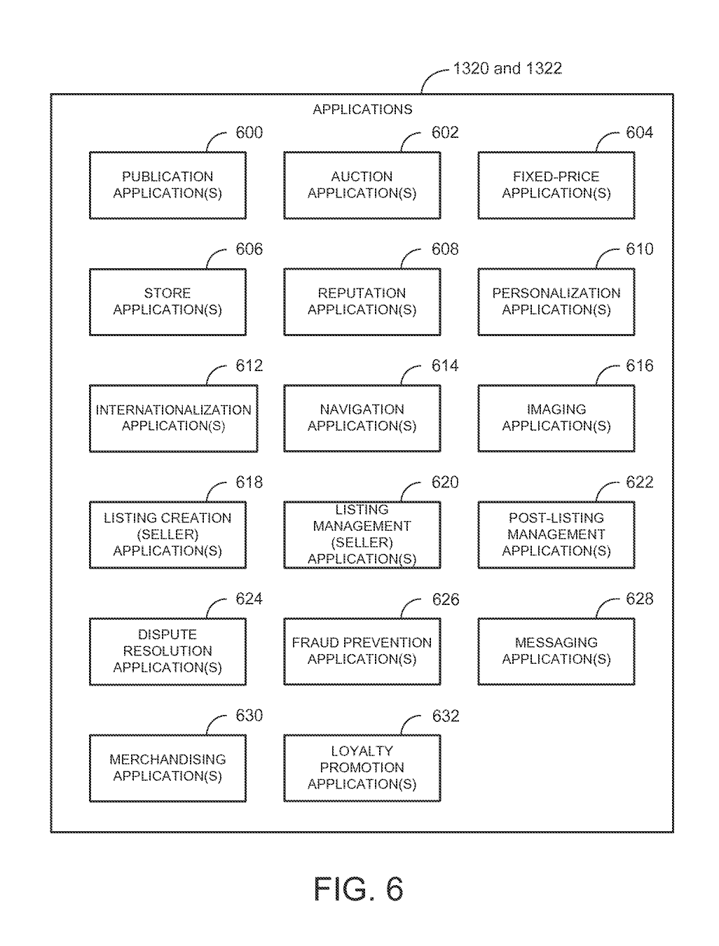

Operation 414 then involves performing, by the second application module 236, a first process in response to the first application module command and the first command data. This may be any process that the second application 236 is structured to provide, including any process associated with any application module illustrated by FIG. 6.

Operation 416 then involves communicating, from the second application module 236 to the communication routing module 149 of URL handler module 240, a second message 260, wherein the second message 260 is sent in response to performing the first process, and wherein the second message 260 is sent using the second protocol name as identified by processing the first message 250. As described above, any of these identifications may be performed by parsing of the associated message. Further, sending the second message 260 in response to the performing of the first process may involve a trigger message being sent by the first process, a second process monitoring resource usage to determine when the first process is complete, or any other such indication associated with the first process.

Operation 418 includes determining, by the communication routing module 149 of URL handler module 240, that the second message 260 comprises the first protocol name. Again, this may be performed by a parsing module within the URL handler module 240, or by any other such means for identifying the first protocol name.

Operation 420 involves communicating, by the communication routing module 149 of URL handler module 240, the second message 260 to the first application module 231 in response to the determination that the second message 260 comprises the first protocol name.

Operation 422 then involves the first application module 231 receiving and processing the second message 260. This may involve parsing the second message 260 to identify a response to the first message 250, such as a confirmation that the first message 250 was received and an associated command was successfully performed. This may involve a second process by the first application module 231 that may be performed in response to a command identified from the second message 260.

While methods 400 and 410, described above in FIGS. 4A and 4B, illustrate example embodiments, it will be apparent that the methods may be performed in accordance with other different embodiments not specifically detailed herein. For example, certain operations described above may be performed in a different order, or with intervening operations. Additionally, other devices may be used which comprise additional elements or elements structured in a different way. Embodiments may use more than two application modules, may use a mixture of application modules and component blocks, may use only component blocks within a single application, or may use other such configurations.

For example, in certain implementations of the methods described above, processing the first message 250 to identify the first application module command, the first command data, and the first protocol name may comprise receiving the first message 250 at a first block communication module of the first application module, wherein the first block communication module comprises a URL parser and parsing the first URL as part of the first message 250 using the URL parser to identify the first application module command, the first command data, and the first protocol name.

As described above, certain embodiments may include component blocks from the same application which communicate with each other. Certain of these embodiments may function in a manner consistent with the methods 400 and 410 described above. Such implementations may operate where the second application module 236 is the first application module 231, where the first protocol name is associated with a first component block of the first application module, and where the second protocol name is associated with a second component block of the first application module. Such implementations may further operate where registering the first application module 231 with a uniform resource locator (URL) handler module 240 of a mobile device 210 to associate a first protocol name with the first application module 231 comprises registering the first component block with the URL handler module 240 to associate the first component block with the first protocol. Such implementations may further operate where registering the second application module 236 with the URL handler of the mobile device 210 to associate a second protocol name with the second application module 236 comprises registering the second component block with the URL handler module 240 to associate the second component block with the second protocol name. Such implementations may further operate where communicating the first message 250 from the first application module 231 to a communication routing module 149 comprises communicating the first message 250 from the first component block to the communication routing module. Such implementations may further operate where communicating the first message 250 to the second application module 236 comprises communicating the first message 250 to the second component block.

Also, in certain implementations of the methods 400 and 410 described above, processing the second message 260 comprises receiving the second message 260 at a second block communication module of the first application module, wherein the second block communication module is different than the first block communication module, and parsing the second message 260 using the second block communication module.

Still further implementations may not only involve communications between two applications and/or component blocks, but may also involve any number of communications with additional application modules or component blocks. One example embodiment may function by implementing the method 400 and the method 401, followed by a number of additional operations.

One such embodiment my include registering a third application module with the URL handler module 240 of the mobile device 210 to associate a third protocol name with the third application module. The embodiment may also involve communicating a third message from the first application module 231 to the communication routing module. The embodiment may also involve determining, by the communication routing module, that the third message comprises the third protocol name. The embodiment may also involve communicating, by the communication routing module, the third message to the third application module in response to the determination that the third message comprises the third protocol name. The embodiment may also involve processing, by the third application module, the third message to identify an application module command and the second protocol name, wherein the second protocol name is identified in a third message callback element. The embodiment may also involve performing, by the third application module, a third process in response to the third application module command. The embodiment may also involve communicating, from the third application module to the communication routing module, a fourth message, wherein the fourth message is sent in response to performing the third process, and wherein the second message 260 is sent using the second protocol name as identified by processing the third message. The embodiment may also involve determining, by the communication routing module, that the fourth message comprises the second protocol name. The embodiment may also involve communicating, by the communication routing module, the fourth message to the second application module 236 in response to the determination that the fourth message comprises the second protocol name.

Still further embodiments may also involve communications and messages by application modules and component blocks that are sent via a network interface to remote networked devices or servers. One embodiment may be implemented by communicating a fifth message from the first application module 231 to a communication routing module. Such an embodiment may additionally involve determining, by the communication routing module, that the fifth message comprises a hypertext transport protocol message. Such an embodiment may also involve communicating, by the communication routing module 149 using a network module of the mobile device, the fifth message to a server identified by a URL of the fifth message.

It will be understood that the above example implementations may be reconfigured with additional intervening operations, or with operations performed in other orders in accordance with the embodiments described herein. Additionally, certain embodiments may comprise mobile devices 110 or any other computing devices that may be specially structured to implement various embodiments. Still further embodiments may comprise non-transitory computer readable memory devices storing instructions that, when executed by a processor, cause a device to perform an embodiment of the innovations described herein.

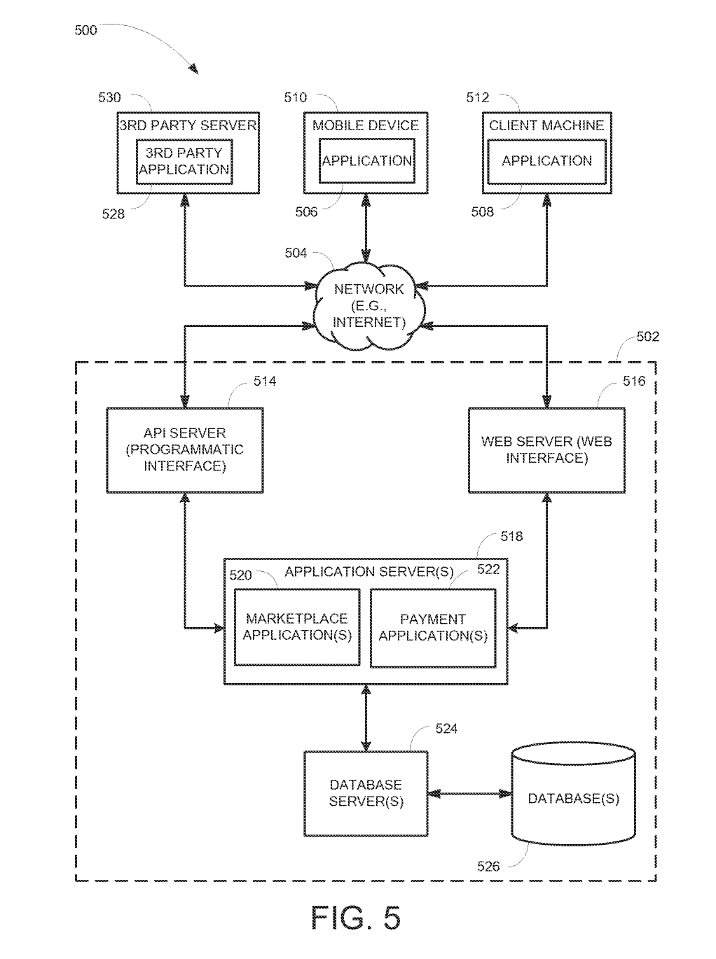

FIG. 5 is a network diagram depicting a network system 500, according to one embodiment, having a client server architecture configured for exchanging data over a network. Such a network system 500 may implement aspects of the embodiments herein, including devices such as mobile devices 110 and 210, and methods such as method 400 and 410. FIG. 5 depicts a client-server system 500, within which one example embodiment may be deployed. For example, the mobile device 110 or 210 may be deployed within the client-server system 500 (e.g., were the mobile device 210 represented by the mobile device 510) or another system.

A networked system 502, in the example forms of a network-based marketplace or publication system, provides server-side functionality, via a network 504 (e.g., the Internet or wide area network (WAN)) to one or more clients. FIG. 5 illustrates, for example, an application 506 (e.g., a browser, such as the Internet Explorer browser developed by Microsoft Corporation of Redmond, Wash. State), and a programmatic client executing on respective mobile devices and client machines 510 and 512. Such a networked system 502 may be used to download application modules such as first and second application modules 231 and 236 onto a mobile device 210. Further, such a networked system 502 may be used to send data to the application modules, and to initiate messages between application modules or component blocks.

An application program interface (API) server 514 and a web server 516 are coupled to, and provide programmatic and web interfaces respectively to, one or more application servers 518. The application servers 518 host one or more marketplace application modules 520 and payment application modules 522. The application servers 518 are, in turn, shown to be coupled to one or more databases servers 524 that facilitate access to one or more databases 526. Thus, in some embodiments, independent elements may communicate not only with each other within a single device, but may also send messages to networked machines and devices. Thus, in certain embodiments, a message from an application module may include a protocol for routing a message via a network 504, such as an H-ITTIP protocol. Such a message may be sent, and a response received, using the same block communication modules which are used to communicate between applications and component blocks.

The marketplace application modules 520 may provide a number of marketplace functions and services to users that access the networked system 502. The payment application modules 522 may likewise provide a number of payment services and functions to users. The payment application modules 522 may enable merchant payments in conjunction with application modules or component blocks operating on a merchant's device. Marketplace applications 520 may also work with application modules operating on a merchant's device to manage inventory, storefront presentations, delivery schedules, and other such marketplace processes. While the marketplace and payment application modules 520 and 522 are shown in FIG. 5 to both form part of the networked system 502, in alternative embodiments the payment application modules 522 may form part of a payment service that is separate and distinct from the networked system 502.

Further, while the system 500 shown in FIG. 5 employs a client-server architecture, embodiments are not limited to such an architecture, and could equally well find application in a distributed, or peer-to-peer, architecture system, for example.

The application 506 may operate with the various applications such as marketplace and payment applications 520 and 522 via the web interface supported by the web server 516. Similarly, the application 508 accesses the various services and functions provided by the marketplace and payment application modules 520 and 522 via the interface provided by the API server 514.

FIG. 5 also illustrates a third party application module 528, executing on a third party server machine 530, as having programmatic access to the networked system 502 via the programmatic interface provided by the API server 514. For example, the third party application module 528 may, utilizing information retrieved from the networked system 502, support one or more features or functions on a website hosted by the third party. The third party may, for example, provide one or more promotional, marketplace, or payment functions that are supported by the relevant application modules of the networked system 502.

FIG. 6 is a block diagram illustrating multiple application modules that may be implemented on a mobile device 510, a client machine 512, or a network server system. Additionally, each of the applications may be integrated into a single application as component blocks. For example, the store application 606 may be the first application module 231, and the fixed-price application 604 may be the second application module 236. Any of these applications may be implemented on a device, and may communicate with each other using embodiments of the innovations described herein. Further, these applications may communicate with other applications operating on other devices, such as marketplace applications 520 or payment applications 522 operating on application servers 518. Such applications may also access remotely stored information via a network 504 by, for example, communicating with database servers 524 using URL communications via block communication modules within each application module or component block.

While details of particular application modules are described herein, any number of other application modules or component blocks may be implemented in various embodiments. Embodiments may include a number of publishing, listing and price-setting application modules whereby a seller may list (or publish information concerning) goods or services for sale, a buyer can express interest in or indicate a desire to purchase such goods or services, and a price can be set for a transaction pertaining to the goods or services. To this end, the application modules may include a publication application module 600 and one or more auction application modules 602 which support auction-format listing and price setting mechanisms (e.g., English, Dutch, Vickrey, Chinese, Double, Reverse auctions etc.). The various auction application modules 602 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price application modules 604 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-form at listings, and allow a buyer to purchase goods or services, which are also being offered for sale via an auction, for a fixed-price that is typically higher than the starting price of the auction.

Store application modules 606 allow a seller to group listings within a “virtual” store, which may be branded and otherwise personalized by and for the seller. Such a virtual store may also offer promotions, incentives and features that are specific and personalized to a relevant seller. Store application modules 606 may additionally include inventory management functions, purchaser history functions, or other such functionality associated with a virtual store.

Reputation application modules 608 allow users that transact, utilizing the networked system 502, to establish, build and maintain reputations, which may be made available and published to potential trading partners. Consider that where, for example, the networked system 502 supports person-to-person trading, users may otherwise have no history or other reference information whereby the trustworthiness and credibility of potential trading partners may be assessed. The reputation application modules 608 allow a user, for example through feedback provided by other transaction partners, to establish a reputation over time. Other potential trading partners may then reference such a reputation for the purposes of assessing credibility and trustworthiness. A reputation application module 608 may also be used by merchants to assess customers, and provide service to customers based on a reputation associated with the customer.

Personalization application modules 610 allow users to personalize various aspects of their interactions with the different application modules. For example, a user may, utilizing an appropriate personalization application module 610, create a personalized reference page at which information regarding transactions to which the user is (or has been) a party may be viewed. Further, a personalization application module 610 may enable a user to personalize listings and other aspects of their interactions with various parties.

Application modules may include a number of marketplaces that are customized, for example, for specific geographic regions. Application modules may be customized for the United Kingdom, whereas another version may be customized for the United States.

Navigation application modules 614 may also be part of a system. This may include modules for navigating a virtual site, or applications for navigating a physical location. For inventory systems, this may provide navigation assistance from a device location to a location of a particular product in storage. Navigation modules may interact with other modules in various ways. For example, a search application module may enable key word searches of listings. A browser application module may allow users to browse various category, catalogue, or system inventory structures according to which listings may be classified within the networked system 502. Various other navigation application modules 614 may be provided to supplement the search and browsing application modules.

Marketplace application modules 520 may include one or more imaging application modules 616 utilizing which users may upload images for inclusion within listings. An imaging application module 616 also operates to incorporate images within viewed listings. The imaging application modules 616 may also support one or more promotional features, such as image galleries that are presented to potential buyers. For example, sellers may pay an additional fee to have an image included within a gallery of images for promoted items.

Listing creation application modules 618 allow sellers conveniently to author listings pertaining to goods or services, and listing management application modules 620 allow sellers to manage such listings. Specifically, where a particular seller has authored and/or published a large number of listings, the management of such listings may present a challenge. The listing management application modules 620 provide a number of features (e.g., auto-relisting, inventory level monitors, etc.) to assist the seller in managing such listings. One or more post-listing management application modules 622 also assist sellers with a number of activities that typically occur post-listing. For example, upon completion of an auction facilitated by one or more auction application modules 602, a seller may wish to leave feedback regarding a particular buyer. To this end, a post-listing management application module 622 may provide an interface to one or more reputation application modules 608, so as to allow the seller conveniently to provide feedback regarding multiple buyers to the reputation application modules 608.

Dispute resolution application modules 624 provide mechanisms whereby disputes arising between transacting parties may be resolved. For example, the dispute resolution application modules 624 may provide guided procedures whereby the parties are guided through a number of steps in an attempt to settle a dispute. In the event that the dispute cannot be settled via the guided procedures, the dispute may be escalated to a merchant mediator or arbitrator.

A number of fraud prevention application modules 626 implement fraud detection and prevention mechanisms to reduce the occurrence of fraud.

Messaging application modules 628 are responsible for the generation and delivery of messages to users of the networked system 502. Messaging application modules 628 may gather information from other modules on a mobile device 110, and then use this information to enable efficient communication of information with other devices. Such messages may, for example, include advising users regarding the status of listings (e.g., providing “outbid” notices to bidders during an auction process or to provide promotional and merchandising information to users). Messaging application modules 628 may also gather information about returns or disputes and aggregate the information with communications between a merchant and a customer as part of a file. This information may then further be distributed to other application modules such as a reputation module, a loyalty module, a fraud prevention module, or other such modules. Respective messaging application modules 628 may utilize any number of message delivery networks and platforms to deliver messages to users. For example, messaging application modules 628 may deliver electronic mail (e-mail), instant message (IM), Short Message Service (SMS), text, facsimile, or voice (e.g., Voice over IP (VoIP)) messages via the wired (e.g., the Internet), telephone service, or wireless (e.g., mobile, cellular, WiFi, WiMAX) networks.

Merchandising application modules 630 support various merchandising functions that are made available to sellers to enable sellers to increase sales. The merchandising application modules 630 also operate the various merchandising features that may be invoked by sellers, and may monitor and track the success of merchandising strategies employed by sellers.

The system users may operate loyalty programs that are supported by one or more loyalty/promotions application modules 632. For example, a buyer may earn loyalty or promotions points for each transaction established and/or concluded with a particular seller, and be offered a reward for which accumulated loyalty points can be redeemed. Such a module may interact with other modules to gather information about which offers or loyalty promotions may be available.

Any of the above application modules, whether implemented as independent application modules or as component blocks, may communicate with any other application module and a network 504 via a block communication module for any purpose allowed by the system. Thus, as described above, each of the above elements, when present in a system, may register with a URL handler module 240, and then communicate with other applications via a communication routing module 149 of the URL handler. In certain embodiments, as part of the registration of each application with the URL handler module 240, each application may send an initialization message to each other application that is already registered to inform the application of the new applications protocol name. In other embodiments, protocol names may be standardized, such that independent elements may be downloaded to a device with the protocol information already present and available to enable messages with the appropriate protocol name for message routing.

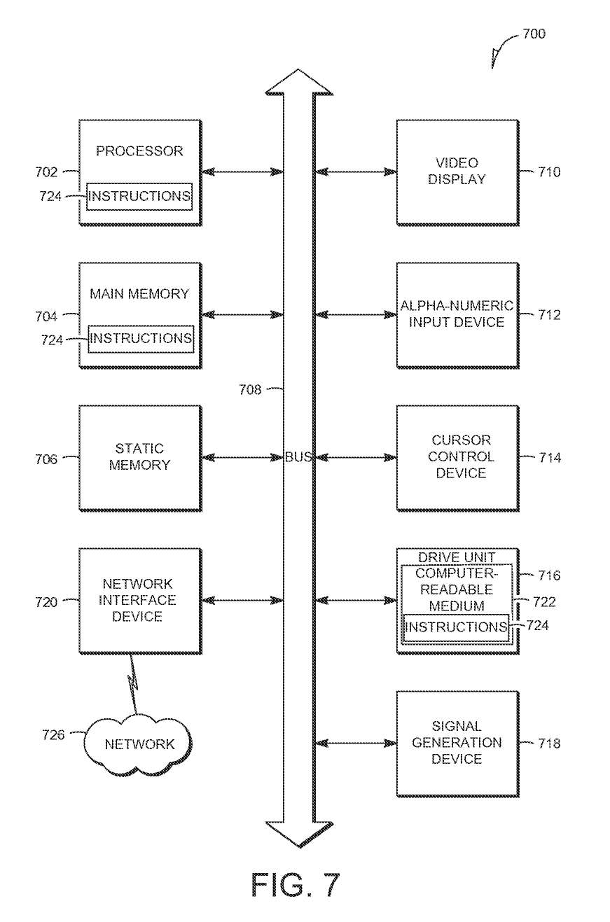

FIG. 7 is a block diagram representation of a machine in the example form of a computer system 700 within which a set of instructions for causing the machine to perform any one or more of the methodologies discussed herein may be executed. A computer system 700 or elements of a computer system similar to computer system 700 may be used to implement any device, machine, or server system described herein, including mobile devices 110 and 210, network system 500, application servers 518, or any other such computing device described herein.

FIG. 7 shows a diagrammatic representation of machine, in the example form of a computer system 700, within which a set of instructions may be executed, causing the machine to perform any one or more of the methods, processes, operations, or methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a tablet computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU) a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a drive unit 716, a signal generation device 718 (e.g., a speaker) and a network interface device 720. In various embodiments, independent elements such as an application module or a component block may interact with any input or output device of a computer system 700 to present a user interface and receive user inputs.

The drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media 722.

The software 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions 724. The term “machine-readable medium” shall also be taken to include any medium that is capable of storing, encoding or carrying a set of instructions 724 for execution by the machine and that cause the machine to perform any one or more of the methodologies of the present innovations. The term “machine-readable medium” shall accordingly be taken to include, but not be limited to, solid-state memories, optical and magnetic media, and carrier wave signals.

Certain systems, apparatus, application modules or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules may be implemented as hardware circuitry, optical components, single or multi-processor circuits, memory circuits, software program modules and objects, firmware, and combinations thereof, as appropriate for particular implementations of various embodiments.

Thus, methods and systems for notification and request processing have been described. Although the present innovations have been described with reference to specific example embodiments, it will be evident that various modifications and changes may be made to these embodiments without departing from the broader spirit and scope of the innovations described herein. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method of communicating information between modules in a mobile device comprising:
registering a first application module with a uniform resource locator (URL) handler module of the mobile device to associate a first protocol name with the first application module;
registering a second application module with the URL handler of the mobile device to associate a second protocol name with the second application module, wherein the second protocol name is different than the first protocol name;
communicating a first message from the first application module to a communication routing module;
determining, by the communication routing module, that the first message comprises the second protocol name;
communicating, by the communication routing module, the first message to the second application module in response to the determination that the first message comprises the second protocol name.

2. The method of claim 1 further wherein the first message comprises the first protocol name in a callback protocol name element of the first message.

3. The method of claim 3 wherein the first message comprises a first URL and wherein the second message comprises a second URL that is different than the first URL.

4. The method of claim 3 further comprising:
processing, by the second application module, the first message to identify a first application module command, first command data, and the first protocol name;
performing, by the second application module, a first process in response to the first application module command and the first command data;
communicating, from the second application module to the communication routing module, a second message, wherein the second message is sent in response to performing the first process, and wherein the second message is sent using the second protocol name as identified by processing the first message;
determining, by the communication routing module, that the second message comprises the first protocol name;
communicating, by the communication routing module, the second message to the first application module in response to the determination that the second message comprises the first protocol name.

5. The method of claim 4 further comprising:
receiving, by the first application module, the second message;
processing, by the first application module, the second message to identify a second application module command and second command data; and
storing the second command data in a memory of the mobile device.

6. The method of claim 5 wherein the second command data comprises a confirmation number associated with completion of the first application module by the second application module.

7. The method of claim 5 wherein processing the first message to identify the first application module command, the first command data, and the first protocol name comprises:
receiving the first message at a first block communication module of the first application module, wherein the first block communication module comprises a URL parser; and
parsing the first URL as part of the first message using the URL parser to identify the first application module command, the first command data, and the first protocol name.

8. The method of claim 7 wherein parsing the first URL comprises:
accessing a first parameter dictionary associated with the first application module, and parsing the first message using the first parameter dictionary.

9. The method of claim 8 wherein the first protocol name is a first resource identifier of the first application module.

10. The method of claim 9 wherein the second application module is the first application module;
wherein the first protocol name is associated with a first component block of the first application module;
wherein the second protocol name is associated with a second component block of the first application module;
wherein registering the first application module with a uniform resource locator (URL) handler module of a mobile device to associate a first protocol name with the first application module comprises registering the first component block with the URL handler module to associate the first component block with the first protocol;
wherein registering the second application module with the URL handler of the mobile device to associate a second protocol name with the second application module, comprises registering the second component block with the URL handler module to associate the second component block with the second protocol name;
wherein communicating the first message from the first application module to a communication routing module comprises communicating the first message from the first component block to the communication routing module; and
wherein communicating the first message to the second application module comprises communicating the first message to the second component block.

11. The method of claim 10 wherein processing the second message comprises:
receiving the second message at a second block communication module of the first application module, wherein the second block communication module is different than the first block communication module; and
parsing the second message using the second block communication module.

12. The method of claim 1 further comprising:
registering a third application module with the URL handler module of the mobile device to associate a third protocol name with the third application module;
communicating a third message from the first application module to the communication routing module;
determining, by the communication routing module, that the third message comprises the third protocol name;
communicating, by the communication routing module, the third message to the third application module in response to the determination that the third message comprises the third protocol name;
processing, by the third application module, the third message to identify an application module command and the second protocol name, wherein the second protocol name is identified in a third message callback element;
performing, by the third application module, a third process in response to the third application module command;
communicating, from the third application module to the communication routing module, a fourth message, wherein the fourth message is sent in response to performing the third process, and wherein the second message is sent using the second protocol name as identified by processing the third message;
determining, by the communication routing module, that the fourth message comprises the second protocol name;
communicating, by the communication routing module, the fourth message to the second application module in response to the determination that the fourth message comprises the second protocol name.

13. The method of claim 1 further comprising:
communicating a fifth message from the first application module to a communication routing module;
determining, by the communication routing module, that the fifth message comprises a hypertext transport protocol message; and
communicating, by the communication routing module using a network module of the mobile device, the fifth message to a server identified by a URL of the fifth message.

14. A device comprising:
a first application module, operating on one or more processor of a device, that registers the first application module with a uniform resource locator (URL) handler module of a mobile device to associate a first protocol name with the first application module, and that communicates a first message from the first application module to a communication routing module;
a second application module, operating on the one or more processors of the device, that registers with the URL handler of the mobile device to associate a second protocol name with the second application module, wherein the second protocol name is different than the first protocol name;
wherein the communication routing module routes the first message from the first application module to the second application module by identifying the second protocol name in the first message.

15. The device of claim 14 wherein the first message comprises a URL; and
wherein the second application module comprises a first URL parser.

16. The device of claim 15 wherein the second application module further:
parses the first message as received from the communication routing module a first application module command, first command data, and the first protocol name;
performs a first process in response to the first application module command and the first command data; and
communicates, to the communication routing module, a second message, wherein the second message is sent in response to performing the process, and wherein the second message is sent using the second protocol name as identified by processing the first message.

17. The device of claim 16, wherein the second message comprises a second URL; and
wherein the first application module comprises a second URL parser that is different than the first URL parser; and
wherein the first application module further:
receives the second message;
parses the second message using the second URL to identify a second application module command and second command data; and
stores the second command data in a memory of the mobile device.

18. The device of claim 17 further comprising:
a third application module comprising a first block component and a second block component;
wherein the first block component comprises a first resource name that is registered with the URL handler as a third protocol; and
wherein the second block component comprises a second resource name that is registered with the URL handler as a fourth protocol.

19. A non-transitory computer readable medium comprising computer readable instructions that, when executed by a processor, cause a device to:
register a first application module with a uniform resource locator (URL) handler module of a mobile device to associate a first protocol name with the first application module;
register a second application module with the URL handler of the mobile device to associate a second protocol name with the second application module, wherein the second protocol name is different than the first protocol name;
communicate a first message from the first application module to a communication routing module;
determine, by the communication routing module, that the first message comprises the second protocol name; and
communicate, by the communication routing module, the first message to the second application module in response to the determination that the first message comprises the second protocol name.

20. The non-transitory computer readable medium of claim 19, wherein the instructions further cause the device to:
process, by the second application module, the first message to identify a first application module command, first command data, and the first protocol name;
perform, by the second application module, a first process in response to the first application module command and the first command data;
communicate, from the second application module to the communication routing module, a second message, wherein the second message is sent in response to performing the first process, and wherein the second message is sent using the second protocol name as identified by processing the first message;
determine, by the communication routing module, that the second message comprises the first protocol name;
communicate, by the communication routing module, the second message to the first application module in response to the determination that the second message comprises the first protocol name; and
receive, by the first application module, the second message;
process, by the first application module, the second message to identify a second application module command and second command data; and
store the second command data in a memory module of the device.
